(19) United States
(12) Patent Application Publication
(10) Pub. No.: US 2021/0133626 A1
(43) Pub. Date: May 6, 2021

(54) APPARATUS AND METHOD FOR OPTIMIZING QUANTIZED MACHINE-LEARNING ALGORITHM

(71) Applicant: ELECTRONICS AND TELECOMMUNICATIONS RESEARCH INSTITUTE, Daejeon (KR)

(72) Inventor: Jin-Wuk SEOK, Daejeon (KR)

(21) Appl. No.: 16/894,306

(22) Filed: Jun. 5, 2020

(30) Foreign Application Priority Data
Nov. 1, 2019 (KR) 10-2019-0138793
Apr. 17, 2020 (KR) 10-2020-0046724

(51) Int. Cl. G06N 20/00; G06F 17/16

(52) U.S. Cl. CPC G06N 20/00; G06F 17/16

(57) ABSTRACT

Disclosed herein are an apparatus and method for optimizing a quantized machine-learning algorithm. The apparatus includes one or more processors and executable memory for storing at least one program executed by the one or more processors. The at least one program sets the learning rate of the quantized machine-learning algorithm using at least one of an Armijo rule and golden search methods, calculates a quantized orthogonal compensation search vector from the search direction vector of the quantized machine-learning algorithm, compensates for the search performance of the quantized machine-learning algorithm using the quantized orthogonal compensation search vector, and calculates an optimized quantized machine-learning algorithm using the learning rate and the quantized machine-learning algorithm, the search performance of which is compensated for.

### CROSS REFERENCE TO RELATED APPLICATIONS

This application claims the benefit of Korean Patent Applications No. 10-2019-0138793, filed Nov. 1, 2019, and No. 10-2020-0046724, filed Apr. 17, 2020, which are hereby incorporated by reference in their entireties into this application.

### BACKGROUND OF THE INVENTION

### 1. Technical Field

The present invention relates generally to machine-learning and signal-processing technology, and more particularly to technology for optimizing a quantized machine-learning algorithm.

### 2. Description of the Related Art

In conventional machine-learning and nonlinear-signal-processing technology, a signal-processing operation is performed based on floating-point operations. However, the conventional machine-learning and nonlinear-signal-processing technology is not suitable for fields in which small and lightweight hardware is required because such technology uses multiple operation modules in order to provide real-time operation and because the size and complexity of a computation module provided for floating-point operations are greater than the size and complexity of a computation module provided for integer operations.

Accordingly, research on quantization of processing data is underway in various engineering fields. Quantization of processing data may confer many advantages, such as a decrease in the number of bits, calculation speed improvement, and availability improvement, when an engineering solution is implemented. For example, because a learning equation of a quantized domain is implemented by updating the least significant bit of a parameter, it is the same as applying a fixed learning speed to an update parameter. However, a general stochastic steepest-descent algorithm having a fixed step size cannot avoid performance degradation because of convergence on the optimum point in weak topology, such as convergence with first-order distribution.

Meanwhile, Korean Patent Application Publication No. 10-2018-0043154, titled “Method and apparatus for neural network quantization” relates to a neural network quantization method, and discloses a method for quantizing the parameters of a neural network, which includes determining the diagonals of a second-order partial derivative matrix (Hessian matrix) of the loss function of the network parameters of the neural network and assigning Hessian weights to the network parameters using the determined diagonals as part of the step of quantizing the network parameters.

### SUMMARY OF THE INVENTION

An object of the present invention is to implement an optimization algorithm capable of minimizing a quantization error in machine-learning and nonlinear-signal-processing fields using quantization and exhibiting excellent performance on lightweight hardware.

Another object of the present invention is to implement a machine-learning algorithm capable of providing sufficient optimization performance even on low-performance hardware.

In order to accomplish the above objects, an apparatus for optimizing a quantized machine-learning algorithm according to an embodiment of the present invention may include one or more processors and executable memory for storing at least one program executed by the one or more processors. The at least one program may set the learning rate of the quantized machine-learning algorithm using at least one of an Armijo rule and golden search methods, calculate a quantized orthogonal compensation search vector from the search direction vector of the quantized machine-learning algorithm, compensate for the search performance of the quantized machine-learning algorithm using the quantized orthogonal compensation search vector, and calculate an optimized quantized machine-learning algorithm using the learning rate and the quantized machine-learning algorithm, the search performance of which is compensated for.

Here, the at least one program may set the learning rate through a learning-rate-setting function predefined by the Armijo rule using the gradient vector of the objective function of the search direction vector.

Here, the at least one program may set any one of a first candidate value, acquired by increasing the minimum candidate value of the learning rate by a golden ratio, and a second candidate value, acquired by decreasing the maximum candidate value of the learning rate by the golden ratio, as the learning rate.

Here, the at least one program may set any one of the first candidate value and the second candidate value as the learning rate when the difference value between the first candidate value and the second candidate value is equal to or less than a preset value.

Here, the at least one program may select a vector in the direction orthogonal to the direction opposite the largest component vector of the search direction vector and quantize the selected vector, thereby calculating the quantized orthogonal compensation search vector.

Here, when the solution of the quantized machine-learning algorithm is not able to escape from a local minimum point, the at least one program may make the solution escape from the local minimum point using the quantized orthogonal compensation search vector.

Also, in order to accomplish the above objects, a method for optimizing a quantized machine-learning algorithm, performed by an apparatus for optimizing the quantized machine-learning algorithm, according to an embodiment of the present invention may include setting the learning rate of the quantized machine-learning algorithm using at least one of an Armijo rule and golden search methods; calculating a quantized orthogonal compensation search vector from the search direction vector of the quantized machine-learning algorithm and compensating for the search performance of the quantized machine-learning algorithm using the quantized orthogonal compensation search vector; and calculating an optimized quantized machine-learning algorithm using the learning rate and the quantized machine-learning algorithm, the search performance of which is compensated for.

Here, setting the learning rate may be configured to set the learning rate through a learning-rate-setting function predefined by the Armijo rule using the gradient vector of the objective function of the search direction vector.

Here, setting the learning rate may be configured to set any one of a first candidate value, acquired by increasing the minimum candidate value of the learning rate by a golden ratio, and a second candidate value, acquired by decreasing the maximum candidate value of the learning rate by the golden ratio, as the learning rate.

Here, setting the learning rate may be configured to set any one of the first candidate value and the second candidate value as the learning rate when the difference value between the first candidate value and the second candidate value is equal to or less than a preset value.

Here, compensating for the search performance may be configured to select a vector in the direction orthogonal to the direction opposite the largest component vector of the search direction vector and to quantize the selected vector, thereby calculating the quantized orthogonal compensation search vector.

Here, compensating for the search performance may be configured such that, when the solution of the quantized machine-learning algorithm is not able to escape from a local minimum point, the solution is made to escape from the local minimum point using the quantized orthogonal compensation search vector.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a flowchart illustrating a method for optimizing a quantized machine-learning algorithm according to an embodiment of the present invention;

FIG. 2 is a flowchart illustrating an optimization algorithm using a quantized Armijo rule according to an embodiment of the present invention;

FIG. 3 is a flowchart illustrating an optimization algorithm using a golden search according to an embodiment of the present invention;

FIG. 4 is a flowchart illustrating an optimization algorithm using a compensated search vector according to an embodiment of the present invention; and

FIG. 5 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

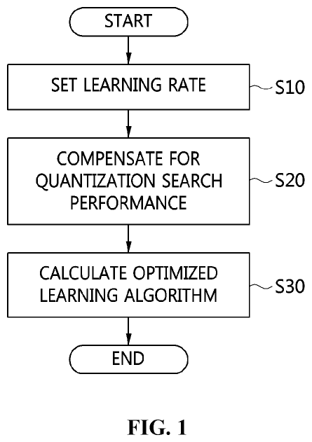

FIG. 1 is a flowchart illustrating a method for optimizing a quantized machine-learning algorithm according to an embodiment of the present invention.

Table 1 shows mathematical symbols used for explaining a quantized machine-learning algorithm according to an embodiment of the present invention.

TABLE 1

| mathematical | |
|---|---|
| symbol | description |
| R | real number space |
| Z | integer space |
| N | natural number space, 0 is not included |
| Rⁿ | n-dimensional vector space of real numbers |
| Zⁿ | n-dimensional vector space of integers |
| R(a, b] | {x\|∀x ∈ R, a < x ≤ b} |
| R[a, b) | {x\|∀x ∈ R, a ≤ x < b} |
| Z[a, b] | {x\|∀x ∈ Z, a ≤ x ≤ b} |
| Z(a, b) | {x\|∀x ∈ Z, a < x < b} |
| δ(x) | Dirac-Delta function, if x = 0, δ(x) = 1, and if x ≠ 0, |
| | δ(x) = 0 |
| [symbol] _{Q}_{ₚ}x | average value of x based on probability distribution for |
| | quantization error caused by quantization coefficient Qₚ |

The definition of learning quantization and main quantization operations according to an embodiment of the present invention may be described as follows.

First, in order to define quantization of a variable x∈R, a round-off operation for obtaining an integer may be defined as shown in Equation (1).

x≡└x┘+ϵ (ϵ∈R[0,1)) (1)

In Equation (1), the symbol └x┘∈Z indicates a round-off operation, which may be defined as the integer that is nearest to x, among integers less than x. Using this, the Gauss symbol may be defined as shown in Equation (2).

[x]+└x+0.5┘=x+0.5−∇ [symbol] x+ϵ (2)

When the operation of rounding x to the nearest number is defined as [x] using Equation (2), the round-off error, ϵ, may be defined as ϵ∈R(−0.5, 0.5┘. Therefore, when an arbitrary integer n E Z is given, the relationships of addition and multiplication may be represented as shown in Equation (3).

[x+n]=└x+n+0.5┘=└x+0.5+n┘=└x+0.5┘+n=[x]+n[n·[x]]=└n−└x+0.5┘+0.5┘=n·└x+0.5┘=n·[x], [n·x]≠n[x] (3)

Also, when an arbitrary real-number sequence {xₖ} (∀k∈N, xₖ∈R) is given, if the round-off operation of each xₖ is represented using ϵₖ as in Equation (1), Equation (4) may be obtained.

$$⌊ {\sum }_{k = 1}^{n} {x}_{k} ⌋ = ⌊ {\sum }_{k = 1}^{n} ( ⌊ {x}_{k} ⌋ + {ϵ}_{k} ) ⌋ = {\sum }_{k = 1}^{n} ⌊ {x}_{k} ⌋ + ⌊ {\sum }_{k = 1}^{n} {ϵ}_{k} ⌋ \qquad ( 4 )$$

Using Equations (1) and (2), a quantization operation may be defined as shown in Equation (5).

$${x}^{Q} {=}^{Δ} \frac{1}{{Q}_{p}} ⌊ {Q}_{p} \cdot ( x + 0.5 ) ⌋ \qquad ( 5 )$$

In Equation (5), Qₚ denotes a quantization coefficient, which may determine the level of quantization. For example, when quantization to a fixed-point number at the level of 10⁻³ is attempted, Qₚ=10³ may be set. For convenience, the quantization coefficient may be set to a positive integer (Qₚ∈Z, Qₚ>0). In order to represent quantization of a specific number without the Gauss symbol, a round-off error is used, whereby Equation (5) may be replaced with Equation (6).

$${x}^{Q} = \frac{1}{{Q}_{p}} [ {Q}_{p} \cdot x ] = \frac{1}{{Q}_{p}} ⌊ Qp \cdot ( x + 0.5 ) ⌋ = \frac{1}{Qp} ( Qp \cdot ( x + ɛ ) ) = x + ɛ \qquad ( 6 )$$

In Equation (6), x^{Q} satisfies x^{Q}∈R, but Qₚx^{Q}=[Qₚ·x]∈Z. That is, in the case of x^{Q}, quantization may be performed to obtain a fixed-point number format, rather than simply an integer.

In Equation (6), the range of the round-off error e may be represented as ε∈R(−0.5Qₚ⁻¹,0.5Qₚ⁻¹]=R(−5·(10Qₚ)⁻¹,5·(10Qₚ)⁻¹]. If Qₚ is large enough that the average value for the distribution of the round-off error depending on Qₚ satisfies E_{Q}_{ₚ}ε=0, the relationship shown in Equation (7) may be satisfied for xₖ, which is the sample data of x.

$$\begin{matrix}{𝔼}_{{Q}_{p}} {x}^{Q} {=}^{Δ} {lim}_{N \to ∞} \frac{1}{N} {\sum }_{k = 0}^{N - 1} {x}_{k}^{Q} = {lim}_{N \to ∞} \frac{1}{N} {\sum }_{k = 0}^{N - 1} ( {x}_{k} + {ɛ}_{k} ) \\ = {𝔼}_{{Q}_{p}} x + {𝔼}_{{Q}_{p}} ɛ = {𝔼}_{{Q}_{p}} x .\end{matrix} \qquad ( 7 )$$

The addition and multiplication of quantized values have the characteristics shown in Equations (4) and (5). However, because the result of division may not be represented as a quantized value, the following method is applied. That is, when division of two integers x and a (x, a∈z) is represented using a quotient and a remainder, division of x by a may be represented as shown in Equation (8).

$$\frac{x}{a} = ⌊ \frac{x}{a} ⌋ + \frac{1}{a} ( x - a ⌊ \frac{x}{a} ⌋ ) \qquad ( 8 )$$

In Equation (8), the quotient may be

$$⌊ \frac{x}{a} ⌋ ,$$

and the remainder may be

$$x - a ⌊ \frac{x}{a} ⌋ .$$

When the Gaussian operation is applied to Equation in order to prove the quotient and the remainder, Equation (9) may be obtained.

$$\begin{matrix}⌊ \frac{x}{a} ⌋ = ⌊ ⌊ \frac{x}{a} ⌋ + \frac{1}{a} ( x - a ⌊ \frac{x}{a} ⌋ ) ⌋ \\ = ⌊ \frac{x}{a} ⌋ + ⌊ \frac{1}{a} ( x - a ⌊ \frac{x}{a} ⌋ ) ⌋\end{matrix} \qquad ( 9 )$$

Equation (9) shows that

$$( x - a ⌊ \frac{x}{a} ⌋ ) < a$$

is satisfied.

Meanwhile, when the rounding operation is applied to Equation (8), Equation (10) may be obtained.

$$\begin{matrix}[ \frac{x}{a} ] = ⌊ \frac{x}{a} + 0.5 ⌋ \\ = ⌊ ⌊ \frac{x}{a} ⌋ + \frac{1}{a} ( x - a ⌊ \frac{x}{a} ⌋ ) + \frac{a}{2 a} ⌋ \\ = ⌊ \frac{x}{a} ⌋ + ⌊ \frac{1}{a} ( x - a ( ⌊ \frac{x}{a} ⌋ - \frac{1}{2} ) ) ⌋\end{matrix} \qquad ( 10 )$$

As a result the conditional expression shown in Equation 11 ma be obtained.

$$[ \frac{x}{a} ] = \{ \begin{matrix}⌊ \frac{x}{a} ⌋ & x < a ( ⌊ \frac{x}{a} ⌋ + \frac{1}{2} ⌋ ) ⇒ a \cdot ɛ > 0 \\ ⌊ \frac{x}{a} ⌋ + 1 & x \geq a ( ⌊ \frac{x}{a} ⌋ + \frac{1}{2} ⌋ ) ⇒ a \cdot ɛ \leq 0\end{matrix} \qquad ( 11 )$$

In Equation (11), the condition that the number added to

$$⌊ \frac{x}{a} ⌋$$

becomes 1 or 0 may be represented as shown in Equation (12). In order for the number to become 1 based on the definition of the Gauss symbol, the condition shown in Equation (12) should be satisfied.

$$\begin{matrix}x - a ( ⌊ \frac{x}{a} ⌋ - 0.5 ) \geq a & ( 12 ) \\ ⇒ x \geq a \cdot ⌊ \frac{x}{a} ⌋ + 0.5 a & \\ ⇒ x \geq a \cdot ( \frac{x}{a} - ϵ ) + 0.5 a ∵ by ( eq 01 : {sec}_{01} ) x = ⌊ x ⌋ + ϵ & \\ ⇒ x \geq x - 0.5 a + ϵ + 0.5 a ∵ by ( eq 02 : {sec}_{01} ) ɛ = 0.5 - ϵ & \\ ⇒ a ɛ \leq 0 & \end{matrix}$$

Particularly, when

$$\vert \frac{x}{a} \vert < 1$$

is satisfied because |x|<|a| is satisfied, this may be expanded to

$${Q}_{p} \vert \frac{x}{a} \vert < {Q}_{p} ,$$

in which case the operation may be represented as shown in Equation (13).

$${Q}_{p} \cdot \frac{x}{a} = ⌊ \frac{{Q}_{p} x}{a} ⌋ + \frac{1}{a} ( {Q}_{p} x - a ⌊ \frac{{Q}_{p} x}{a} ⌋ ) \qquad ( 13 )$$

Through Equations (5) and (13), quantization of division may be derived as Equation (14). First, the function, g(x,a)∈{0,1}, may be defined as shown in Equation (14).

$$g ( x , a ) = ⌊ \frac{1}{a} ( {Q}_{p} x - a ( ⌊ \frac{{Q}_{p} x}{a} ⌋ - \frac{1}{2} ) ) ⌋ = \{ \begin{matrix}1 & a \cdot ɛ \leq 0 \\ 0 & a \cdot ɛ > 0\end{matrix} \qquad ( 14 )$$

When quantization for division is interpreted using Equation (14), this may be represented as shown in Equation (15):

$$\begin{matrix}\frac{1}{{Q}_{p}} [ {Q}_{p} \cdot \frac{x}{a} ] = \frac{1}{{Q}_{p}} ⌊ ⌊ \frac{{Q}_{p} x}{a} ⌋ + \frac{1}{a} ( {Q}_{p} x - a ( ⌊ \frac{{Q}_{p} x}{a} ⌋ - \frac{1}{2} ) ) ⌋ \\ = \frac{1}{{Q}_{p}} ⌊ \frac{{Q}_{p} x}{a} ⌋ + \frac{1}{{Q}_{p}} ⌊ \frac{1}{a} ( {Q}_{p} x - a ( ⌊ \frac{{Q}_{p} x}{a} ⌋ - \frac{1}{2} ) ) ⌋ \\ = \frac{1}{{Q}_{p}} ( ⌊ \frac{{Q}_{p} x}{a} ⌋ + g ( x , a ) )\end{matrix} \qquad ( 15 )$$

Based on the definition of learning quantization and main quantization operations according to an embodiment of the present invention, it may be understood that, when quantization based on the distribution of a remainder value is performed, the smallest value is 1 or 0.

Referring to FIG. 1, in the method for optimizing a quantized machine-learning algorithm according to an embodiment of the present invention, a learning rate may be set at step S10.

When the above-described quantization method is expanded to a vector, this may be defined in such a way that quantization is applied to the elements of each vector. At step S10, using the method of applying quantization to the elements of each vector, the quantization characteristics of a learning equation may be analyzed.

For example, it may be assumed that the learning equation shown in Equation (16) is given for x(t)∈Rⁿ.

xₜ₊₁=xₜ−λₜhₜ (16)

In Equation (16), hₜ∈Rⁿ is a search direction vector, λₜ∈R(0,1] is a learning rate, and t∈R is a parameter related to time. In Equation (16), when quantization of xₜ is defined as xₜ^{Q}≡[x]ₜ, the quantized learning equation shown in Equation (17) may be defined.

xₜ₊₁^{Q}=(xₜ−λₜhₜ)^{Q} (17)

In Equation (17), λₜ denotes a learning rate. Using hₜ, xₜ or xₜ^{Q} may be updated to xₜ₊₁^{Q} through the update term of Equation (18).

λₜhₜ=(λₜhₜ)^{Q} (18)

Additionally, it is assumed that the following basic condition for the learning rate is satisfied.

λᵢ=arg min ƒ(xᵢ−λhᵢ) (19)

Here, when Equation (17), which is a quantized learning equation, is rewritten by substituting the quantized xₜ^{Q} for xₜ and by applying Equation (18), which is a quantized update term, Equation (20) may be obtained.

xₜ₊₁^{Q}=(xₜ^{Q}−(λₜhₜ)^{Q})^{Q}=xₜ^{Q}−(λₜhₜ)^{Q} (20)

In Equation (20), because the learning rate λₜ∈R and the search direction vector hₜ∈Rⁿ are a scalar and a vector, respectively, it is relatively difficult to implement quantization satisfying λₜhₜ=(λₜhₜ)^{Q}. Therefore, even though the optimized learning rate is found through a line search algorithm, it is required to recalculate it so as to enable quantization.

The most intuitive quantization of the update term is to set λₜ=1/Qₚ. As the result thereof,

$${λ}_{t} {h}_{t} = \frac{1}{{Q}_{p}} {h}_{t}$$

is satisfied, and the quantized update term may be represented as shown in Equation (21).

$${( {λ}_{t} {h}_{t} )}^{Q} = \frac{1}{{Q}_{p}} ( {Q}_{p} {λ}_{t} {h}_{t} + {Q}_{p} ɛ ) = \frac{1}{{Q}_{p}} {h}_{t} + ɛ = {( \frac{1}{{Q}_{p}} {h}_{t} )}^{Q} \qquad ( 21 )$$

Based on this, the function z(kₜ)∈Z, z(kₜ)>0, which outputs an arbitrary positive integer for the internal iteration index kₜ in the t-th iteration, is defined, and using this function, the learning rate λₜ is set to λₜ=z(kₜ)Qₚ⁻¹. Accordingly, the update term may be represented as shown in Equation (22).

$${( {λ}_{t} {h}_{t} )}^{Q} = \frac{z ( {k}_{t} )}{{Q}_{p}} {h}_{t} + ɛ = {( \frac{z ( {k}_{t} )}{{Q}_{p}} {h}_{t} )}^{Q} \qquad ( 22 )$$

If quantization is defined well so as to satisfy

$$\frac{1}{{Q}_{p}} {h}_{t} ∈ Z$$

by appropriately defining Equation (22) (or if quantization can be defined through the internal characteristics of a calculator), because z(kₜ)∈Z is satisfied, Equation (23) may be obtained.

$${( \frac{z ( {k}_{t} )}{{Q}_{p}} {h}_{t} )}^{Q} = z ( {k}_{t} ) {( \frac{1}{{Q}_{p}} {h}_{t} )}^{Q} \qquad ( 23 )$$

In Equation (23), z(kₜ)∈Z(0,Qₚ) is satisfied. When the well-defined

$$\frac{1}{{Q}_{p}} {h}_{t} ∈ Z$$

is assumed to be a basic quantization search direction vector, Equation (24) may be defined.

$${h}_{t}^{Q} {=}^{Δ} {( \frac{1}{{Q}_{p}} {h}_{t} )}^{Q} , {h}_{t}^{Q } ∈ Z \qquad ( 24 )$$

When Equation (22) is rewritten using Equation (24), Equation (25) may be obtained.

(λₜhₜ)^{Q}=z(kₜ)hₜ^{Q} (25)

That is, at step S10, the learning rate of the quantized machine-learning algorithm may be set using at least one of an Armijo rule and golden search methods.

Here, at step S10, using the gradient vector of the objective function of the search direction vector, the learning rate may be set based on a learning-rate-setting function predefined by the Armijo rule.

Here, at step S10, any one of a first candidate value, which is acquired by increasing the minimum candidate value of the learning rate by a golden ratio, and a second candidate value, which is acquired by decreasing the maximum candidate value of the learning rate by the golden ratio, may be set as the learning rate.

Here, at step S10, when the difference value between the first candidate value and the second candidate value is equal to or less than a preset value, any one of the first candidate value and the second candidate value may be set as the learning rate.

Also, in the method for optimizing a quantized machine-learning algorithm according to an embodiment of the present invention, quantization search performance may be compensated for at step S20.

That is, at step S20, a quantized orthogonal compensation search vector may be calculated from the search direction vector of the quantized machine-learning algorithm, and the search performance of the quantized machine-learning algorithm may be compensated for using the quantized orthogonal compensation search vector.

Here, at step S20, a vector in the direction orthogonal to the direction opposite the largest component vector of the search direction vector is selected, and the selected vector is quantized, whereby the quantized orthogonal compensation search vector may be calculated.

Here, at step S20, when the solution of the quantized machine-learning algorithm is not able to escape from a local minimum point, the solution may be made to escape from the local minimum point using the quantized orthogonal compensation search vector.

Also, in the method for optimizing a quantized machine-learning algorithm according to an embodiment of the present invention, an optimized learning algorithm may be calculated at step S30.

That is, at step S30, the optimized quantized machine-learning algorithm may be calculated using the learning rate and the quantized machine-learning algorithm, the search performance of which is compensated for.

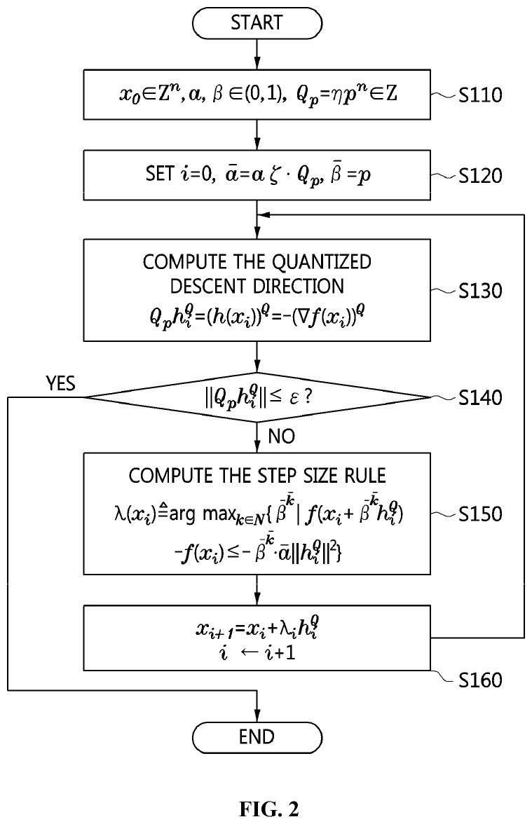

FIG. 2 is a flowchart illustrating an optimization algorithm using a quantized Armijo rule according to an embodiment of the present invention.

Referring to FIG. 2, the process of setting the learning rate of a quantized machine-learning algorithm to which the Armijo rule is applied at step S10 is specifically illustrated.

First, at step S110, a quantization parameter may be set.

Also, at step S120, a learning-rate-setting parameter may be set.

Also, at step S130, a search direction vector may be calculated.

The search direction vector hₜ is the gradient vector of an objective function ƒ(x) and is represented as hₜ=∇ƒ(xₜ), and the function for setting the learning rate may be represented as shown in Equation (26).

ϕ(β^{k})=β^{k}α∥hₜ∥² (26)

Also, at step S140, when the error of the search direction vector is equal to or less than a preset value, the optimization of the quantized machine-learning algorithm is terminated, but when the error is greater than the preset value, the learning rate may be set at step S150.

At step S150, the learning rate may be set using Equation (27) to which the Armijo rule is applied.

$${λ}_{t} {=}^{Δ} {argmax}_{k ∈ N} [ {β}^{k} \vert f ( {x}_{t} + {β}^{k} {h}_{t} ) - f ( {x}_{t} ) \leq - {β}^{k} α {‖ {h}_{t} ‖}^{2} = ϕ ( {β}^{k} ) ] α , β ∈ R ( 0 , 1 ) \qquad ( 27 )$$

Finally, the quantization parameter may be configured with positive integers, as shown in Equation (28).

Qₚ=η·ρⁿ η,ρ, n∈Z⁺⁺ (28)

Because λₜ=ϕ(β^{k}) is satisfied in the definition of the learning rate, the Armijo rule may be modified so as to satisfy the characteristics of the quantized learning rate in Equation (23). First, assuming that the search direction vector is the basic quantization search direction vector and is represented as hₜ [symbol] (hₜ)^{Q}=Qₚhₜ^{Q}, Equation (29) may be obtained.

$$\begin{matrix}ϕ ( {β}^{k} ) = - {β}^{k} α {‖ {h}_{t} ‖}^{2} \\ = - {β}^{k} α {‖ {( {h}_{t} )}^{Q} ‖}^{2} \\ = - {β}^{k} α {‖ {Q}_{p} {h}_{t}^{Q} ‖}^{2} \\ = - {β}^{k} {αQ}_{p}^{2} {‖ {h}_{t}^{Q} ‖}^{2} ∵ {Q}_{p} ∈ Z , {Q}_{p} > 0 \\ = - ( {β}^{k} {Q}_{p} ) \cdot ( {αQ}_{p} ) {‖ {h}_{t}^{Q} ‖}^{2} \\ = - ( {β}^{k} {ηρ}^{n} ) \cdot ( α {ηρ}^{n} ) {‖ {h}_{t}^{Q} ‖}^{2} \\ = - ( {β}^{k} {ρ}^{n} ) \cdot ( α {η}^{2} {ρ}^{n} ) {‖ {h}_{t}^{Q} ‖}^{2}\end{matrix} \qquad ( 29 )$$

Equation (29) may be solved as shown in Equation (30).

$$ϕ ( {\overline{β}}^{\overline{k}} ) ≡ - ( {\overline{β}}^{\overline{k}} ) \cdot \overline{α} {‖ {h}_{t}^{Q} ‖}^{2} , 0 < {\overline{β}}^{max \overline{k}} \leq \frac{{Q}_{p}}{η} , 0 < \overline{α} \leq η \cdot {Q}_{p} \qquad ( 30 )$$

Because α and β are arbitrary values satisfying α,β∈R(0,1), an integer that is equal to or less than η is taken (that is, ζ≤η) for α in Equation (30), whereby the condition for a may be satisfied as shown in Equation (31).

$$\overline{α} = ζ \cdot {Q}_{p} ∈ Z , η < \overline{α} \leq η \cdot {Q}_{p} ∵ α = \frac{ζ}{η} \qquad ( 31 )$$

Also, when β=ρ⁻¹ is set, β̅ may be represented as shown in Equation (32) for the fixed value n.

$${\overline{β}}^{\overline{k}} = {β}^{k} {ρ}^{n} = {ρ}^{- k} {ρ}^{n} = {p}^{n - k} , 0 < \overline{k} \leq n \qquad ( 32 )$$

Therefore, β̅ and k̅ are defined as β̅=ρ, k̅=n−k, and because max k̅=n is satisfied, Equation (33) may be obtained.

$${\overline{β}}^{max \overline{k}} = {ρ}^{n} = \frac{{Q}_{p}}{η} \qquad ( 33 )$$

Therefore, when the objective function ƒ:Rⁿ→R is configured so as to satisfy ƒ:Zⁿ→Z for zⁿ and when h₀ is configured so as to satisfy h₀=−∇ƒ(x₀)∈Z, the learning rate λₜ^{Q} based on the Armijo rule may be calculated using only the integer operations shown in Equation (34), and may then be applied to the quantized machine-learning algorithm at step S150.

$${λ}_{t}^{Q} {=}^{Δ} {argmax}_{\overline{k} ∈ N} \{ {\overline{β}}^{\overline{k}} \vert f ( {x}_{t} + {\overline{β}}^{\overline{k}} {h}_{t} ) - f ( {x}_{t} ) \leq - {\overline{β}}^{\overline{k}} \overline{α} {‖ {h}_{t}^{Q} ‖}^{2} = ϕ ( {\overline{β}}^{\overline{k}} ) \} \qquad ( 34 )$$

Also, at step S160, the quantized learning equation may be updated using the set learning rate.

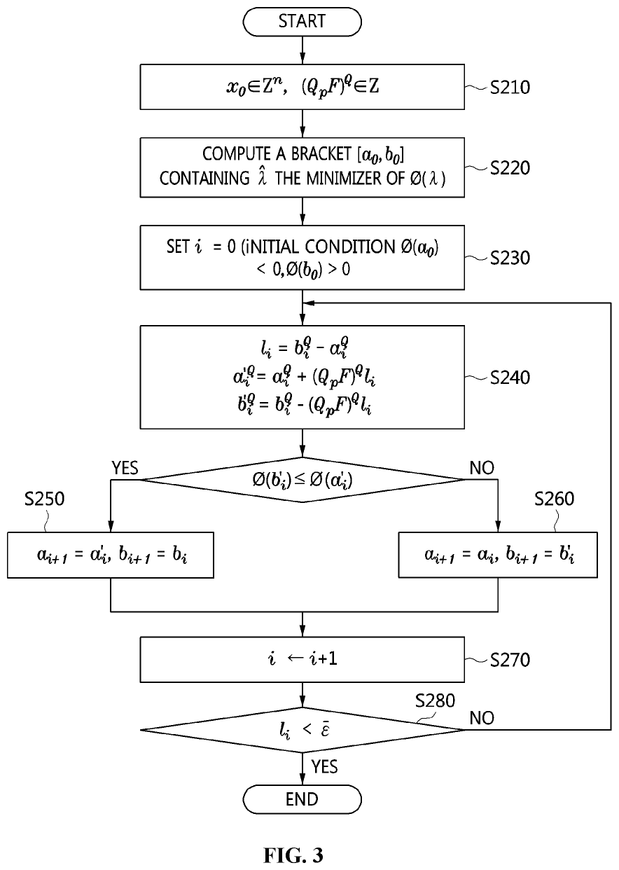

FIG. 3 is a flowchart illustrating an optimization algorithm using a golden search according to an embodiment of the present invention.

Referring to FIG. 3, the process of setting the learning rate of a quantized machine-learning algorithm to which a golden search method is applied at step S10 is specifically illustrated.

The golden search method is a method for finding the optimized learning rate, like the Armijo rule and a learning rate satisfying Equation 35 may be set.

$${min}_{λ \geq 0} \{ f ( {x}_{i} + λ {h}_{i} ) \} ⇒ Let ϕ ( λ ) = f ( {x}_{i} + λ {h}_{i} ) - f ( {x}_{i} ) ⇒ {min}_{λ} ϕ ( λ ) \qquad ( 35 )$$

First, at step S210, a quantization parameter may be set.

Also, at step S220, a search range for applying the golden search method may be set.

Also, at step S230, an initial condition for applying the golden search method may be set.

Here, at step S230, when quantization is not applied, a₀=0 and b₀=1 may be set and hₜ=Qₚhₜ^{Q} may be set.

Also, at step S240, the golden search method may be applied.

Here, at step S240, the i-th search range 1, may be defined as shown in Equation (36).

lᵢ [symbol] bᵢ−aᵢ (36)

Here, aᵢ and bᵢ may be the minimum candidate value and the maximum candidate value for the learning rate A.

Here, at step S240, when the value of the search range 1, is made to approach 0 by increasing the minimum candidate value by a golden ratio and decreasing the maximum candidate value by the golden ratio using the golden search method, one of the minimum candidate value and the maximum candidate value may be set as the learning rate.

The golden ratio used for the golden search may be F₀=0.618.

Also, at steps S250 to S280, the minimum candidate value and the maximum candidate value may be updated.

Here, the update of the minimum candidate value and the maximum candidate value may be represented as shown in Equation (37).

a′ᵢ=aᵢ+(1−F₀)lᵢ, b′ᵢ=bᵢ−(1−F₀)lᵢ (37)

Because aᵢ and bᵢ are set to aᵢ,bᵢ∈R(0,1) in Equation (37), quantization thereof is required.

Using Equations (24) and (25), the quantized learning equation shown in Equation (38) may be calculated.

xₜ₊₁^{Q}=xₜ^{Q}−(λₜhₜ)^{Q}=xₜ^{Q}−(λₜQₚhₜ^{Q})^{Q}=xₜ^{Q}−(λₜQₚ)^{Q}hₜ^{Q} (38)

In Equation (38), because (λₜQₚ)^{Q} is a value that falls within the range of z(0,Qₚ), when λₜ^{Q} [symbol] (λₜQₚ) is set, Equation (39) may be obtained.

aᵢ^{Q}≡(aᵢQₚ)^{Q}, bᵢ≡(bᵢQₚ)^{Q}, aᵢ,bᵢ∈Z(0,Qₚ) (39)

Equation (39) may be solved as a quantized operation using the golden search method. To this end, F̅=1−F₀ is set first, and the equation for the minimum candidate in Equation (37) is multiplied by Qₚ, whereby Equation (40) may be obtained.

a′ᵢQₚ=aᵢQₚ+Qₚ(1−F₀)lᵢ

a′ᵢQₚ=aᵢQₚ+QₚF̅lᵢ

(a′ᵢQₚ)^{Q}=(aᵢQₚ+QₚF̅lᵢ)^{Q} (40)

The error resulting from quantization is taken into consideration, and because lᵢ=bᵢ^{Q}−aᵢ^{Q}∈Z is satisfied as the result of quantization, Equation (41) may be obtained.

a′ᵢ^{Q}=(aᵢQₚ)^{Q}+(QₚF̅)^{Q}lᵢ+O(ε) (41)

Because this is the operation for setting the learning rate, when the quantization error is ignored, Equations (39) and (41) may be solved as shown in Equation (42).

a′ᵢ^{Q}=aᵢ^{Q}+(QₚF̅)^{Q}lᵢ, b′ᵢ^{Q}=bᵢ^{Q}−(QₚF̅)^{Q}lᵢ ∀i∈N, aᵢ^{Q},bᵢ^{Q}∈Z(0,Qₚ) (42)

Because the learning rate set through the above process satisfies λₜ^{Q}^{_{L}}∈Z(0,Qₚ), when this is applied to the quantization unit search vector hₜ^{Q}, the following quantized learning equation may be obtained.

xₜ₊₁^{Q}=xₜ^{Q}−λₜ^{Q}^{_{L}}hₜ^{Q} (43)

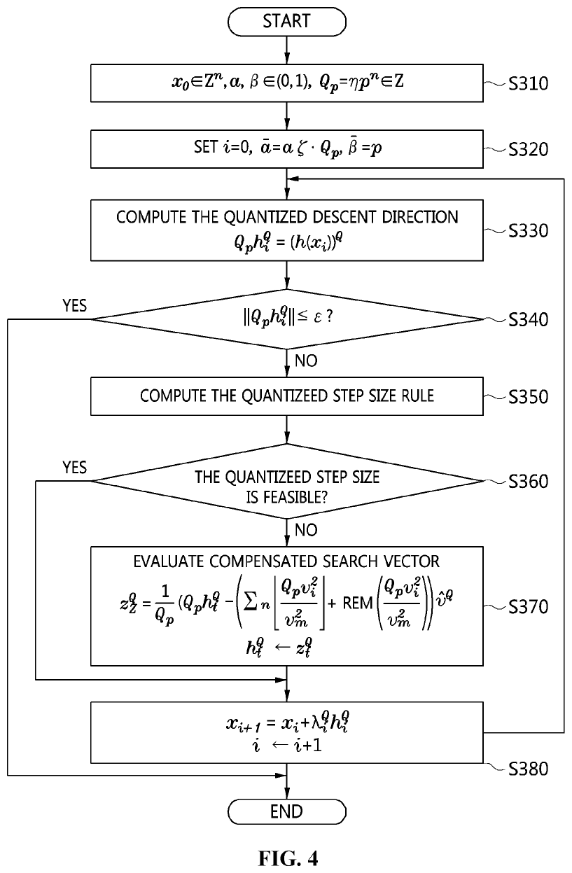

FIG. 4 is a flowchart illustrating an optimization algorithm using a compensated search vector according to an embodiment of the present invention.

Referring to FIG. 4, the process of compensating for the search performance of a quantized machine-learning algorithm at step S20 is specifically illustrated.

Here, at step S20, a point that makes an objective function smaller in a different direction other than a search direction vector is searched for, whereby optimization performance degradation may be overcome.

First, at step S310, a quantization parameter may be set.

Also, at step S320, an initial parameter may be set.

Also, at step S330, a search direction vector may be calculated.

Also, at step S340, when the error of the search direction vector is equal to or less than a preset value, the optimization of the quantized machine-learning algorithm is terminated, but when the error is greater than the preset value, a learning rate may be set at step S350.

At step S350, the learning rate may be set using the Armijo rule and the golden search method, as described with reference to FIG. 2 and FIG. 3.

Also, at step S360, whether the quantized learning equation using the set learning rate reaches a local minimum point is determined. When the quantized learning equation is determined not to reach the local minimum point, the search direction vector may be compensated for at step S370.

Here, at step S360, with regard to performance degradation, it may be checked whether the optimization parameter x, cannot converge near the local minimum point because the appropriate learning rate enabling arrival at the local minimum point cannot be applied due to quantization or whether a better minimum point cannot be found.

For the search direction vector hₜ∈Rⁿ, the quantized vector (hₜ)^{Q}=Qₚhₜ^{Q}∈Rⁿ may be represented as shown in Equation (44).

$${( {h}_{t} )}^{Q} = {\sum }_{i = 0}^{n - 1} {v}_{i} {e}_{i} , ∀ i ∈ Z [ 0 , n - 1 ] , {v}_{i} ∈ Z \qquad ( 44 )$$

Here, at step S370, the different direction is the direction orthogonal to the search direction. Because a vector orthogonal to the search direction vector may have various vector directions, the vector in the direction orthogonal to the direction opposite the largest component vector of the search direction vector may be selected.

In Equation (44), eᵢ is the unit orthogonal vector of Euclidian space Rⁿ and satisfies ∀i,j∈Z[0,n), ∥eᵢ∥=1, eᵢ^{T}eⱼ=0 i≠j. Assume that the largest component, among the components {vᵢ} of the quantized vector (hₜ)^{Q}, is vₘ=max{∥vᵢ∥}, and that the index thereof is m=argmaxᵢ{∥vᵢ∥}. Here, when the vector acquired by setting vₘ=0 in the quantized vector (hₜ)^{Q} is v̅ and when the vector in which all of the components excluding vₘ are 0 is 0, v̅ and \hat{v} may be defined as shown in Equation (45).

$$\overline{v} = {\sum }_{i = 0}^{n - 1} ( 1 - δ ( i - m ) ) {v}_{i} {e}_{i} , \hat{v} = {\sum }_{i = 0}^{n - 1} δ ( i - m ) {v}_{i} {e}_{i} \qquad ( 45 )$$

Therefore, the search direction vector may be divided into two orthogonal vectors v̅ and \hat{v}, as shown in Equation (46).

$${( {h}_{t} )}^{Q} = \overline{v} + \hat{v} = {\sum }_{i = 0}^{n - 1} ( 1 - δ ( i - m ) + δ ( i - m ) ) {v}_{i} {e}_{i} = {\sum }_{i = 0}^{n - 1} {v}_{i} {e}_{i} \qquad ( 46 )$$

At step S370, vector z may be calculated as shown in Equation (47) in order to obtain the vector in the direction orthogonal to the largest component in the existing search direction vector (hₜ)^{Q}.

zₜ=v̅+r·\hat{v}, r∈R (47)

In Equation (47), r∈R is a proportional constant for \hat{v}, and through this value, the orthogonal vector z may be calculated. Using the orthogonality between the vector z and the vector (hₜ)^{Q}, r may be calculated as shown in Equation (48).

$$\begin{matrix}\begin{matrix}0 = 〈 {( {h}_{t} )}^{Q} , z 〉 = 〈 \overline{v} + \hat{v} , \overline{v} + r \hat{v} 〉 \\ = {\overline{v}}^{2} + ( r + 1 ) 〈 \hat{v} , \overline{v} 〉 + r {\hat{v}}^{2} ∵ 〈 \hat{v} , \overline{v} 〉 = 0 \\ = {\overline{v}}^{2} + r {\hat{v}}^{2}\end{matrix} & ( 48 ) \\ ∴ r = - \frac{{\overline{v}}^{2}}{{\hat{v}}^{2}} = - \frac{{‖ {( {h}_{t} )}^{Q} ‖}^{2} - {v}_{m}^{2}}{{v}_{m}^{2}} = 1 - \frac{{‖ {( {h}_{t} )}^{Q} ‖}^{2}}{{v}_{m}^{2}} & \end{matrix}$$

However, because |r|<1 is satisfied, when this value is applied to the learning equation without change, the operation is not performed using an integer value.

Accordingly, the compensated search vector may become a general real number vector, rather than a vector configured with quantized values. Therefore, at step S370, the compensated search vector may be calculated in consideration of quantization of the proportional constant.

In Equation (47), because (hₜ)^{Q}=Qₚhₜ^{Q} is satisfied, when the equation is solved using vₘ=Qₚvₘ^{Q}, Equation (49) may be obtained.

$$\hat{v} = {\sum }_{i = 0}^{n - 1} δ ( i - m ) {v}_{i} {e}_{i} = {Q}_{p} \cdot {v}_{m}^{Q} {e}_{m} \qquad ( 49 )$$

In Equation (49), when vₘ^{Q}eₘ [symbol] \hat{v}^{Q} is set, Equation (50) may be obtained.

$$\begin{matrix}{z}_{t} = \overline{v} + r \cdot \hat{v} + r \cdot {Q}_{p} {\hat{v}}^{Q} = \overline{v} + {Q}_{p} r \cdot {\hat{v}}^{Q} \\ = \overline{v} + {Q}_{p} {\hat{v}}^{Q} - {Q}_{p} {\hat{v}}^{Q} + {Q}_{p} r \cdot {\hat{v}}^{Q} \\ = ( \overline{v} + \hat{v} ) + {Q}_{p} ( r - 1 ) {\hat{v}}^{Q} ∵ \hat{v} = {Q}_{p} {\hat{v}}^{Q}\end{matrix} \qquad ( 50 )$$

Based on Equations (46) and (48) and (hₜ)^{Q}=Qₚhₜ^{Q}, Equation (51) may be obtained.

$${z}_{t} = {Q}_{p} {h}_{t}^{Q} - {Q}_{p} \frac{{‖ {( {h}_{t} )}^{Q} ‖}^{2}}{{v}_{m}^{2}} {\hat{v}}^{Q} \qquad ( 51 )$$

Accordingly, when the coefficient of \hat{v}^{Q} is solved using Equations (11) and (25), Equation (52) may be obtained.

$${Q}_{p} \cdot \frac{{‖ {( {h}_{t} )}^{Q} ‖}^{2}}{{v}_{m}^{2}} = {Q}_{p} \cdot \frac{{\sum }_{i = 0}^{n - 1} {v}_{i}^{2}}{{v}_{m}^{2}} = {\sum }_{i = 0}^{n - 1} \frac{{Q}_{p} {v}_{i}^{2}}{{v}_{m}^{2}} \qquad ( 52 )$$

Accordingly, when the compensated search vector zₜ is quantized using Equations (51) and (52), Equation (53) may be obtained.

$$\begin{matrix}{( {z}_{t} )}^{Q} = {( {Q}_{p} {h}_{t}^{Q} - {Q}_{p} \frac{{‖ {( {h}_{t} )}^{Q} ‖}^{2}}{{v}_{m}^{2}} {\hat{v}}^{Q} )}^{Q} \\ = {Q}_{p} {h}_{t}^{Q} - {( {\sum }_{i = 0}^{n - 1} \frac{{Q}_{p} {v}_{i}^{2}}{{v}_{m}^{2}} )}^{Q} {\hat{v}}^{Q} \\ = {Q}_{p} {h}_{t}^{Q} - ⌊ {\sum }_{i = 0}^{n - 1} \frac{{Q}_{p} {v}_{i}^{2}}{{v}_{m}^{2}} + 0.5 ⌋ {\hat{v}}^{Q} \\ = {Q}_{p} {h}_{t}^{Q} - ⌊ {\sum }_{i = 0}^{n - 1} \{ ⌊ \frac{{Q}_{p} {v}_{i}^{2}}{{v}_{m}^{2}} ⌋ + \frac{1}{{v}_{m}^{2}} ( {Q}_{p} {v}_{t}^{2} - {v}_{m}^{2} ⌊ \frac{{Q}_{p} {v}_{i}^{2}}{{v}_{m}^{2}} ⌋ ) \} + 0.5 ⌋ {\hat{v}}^{Q}\end{matrix} \qquad ( 53 )$$

Therefore, Equation (53) may be solved to Equation (54) using Equation (4).

$${( {z}_{t} )}^{Q} = {Q}_{p} {h}_{t}^{Q} - ( {\sum }_{i = 0}^{n - 1} ⌊ \frac{{Q}_{p} {v}_{i}^{2}}{{v}_{m}^{2}} ⌋ + ⌊ {\sum }_{i = 0}^{n - 1} \frac{1}{{v}_{m}^{2}} ( {Q}_{p} {v}_{t}^{2} - {v}_{m}^{2} ⌊ \frac{{Q}_{p} {v}_{i}^{2}}{{v}_{m}^{2}} ⌋ + 0.5 ⌋ ) {\hat{v}}^{Q} \qquad ( 54 )$$

In Equation (54),

$$⌊ \frac{{Q}_{p} {v}_{i}^{2}}{{v}_{m}^{2}} ⌋$$

and

$${Q}_{p} {v}_{i}^{2} - {v}_{m}^{2} ⌊ \frac{{Q}_{p} {v}_{i}^{2}}{{v}_{m}^{2}} ⌋$$

are the quotient and remainder of

$$\frac{{Q}_{p} {v}_{i}^{2}}{{v}_{m}^{2}} .$$

The part corresponding to the remainder may be simplified as shown in Equation (55).

$$Rem ( \frac{{Q}_{p} {v}_{i}^{2}}{{v}_{m}^{2}} ) = \frac{1}{{v}_{m}^{2}} ( {Q}_{p} {v}_{i}^{2} - {v}_{m}^{2} ⌊ \frac{{Q}_{p} {v}_{i}^{2}}{{v}_{m}^{2}} ⌋ ) \qquad ( 55 )$$

The quantized orthogonal compensation search vector may be represented as shown in Equation (56).

$${( {z}_{t} )}^{Q} = {Q}_{p} {h}_{t}^{Q} - ( {\sum }_{i = 0}^{n - 1} ⌊ \frac{{Q}_{p} {v}_{i}^{2}}{{v}_{m}^{2}} ⌋ + [ Rem ( \frac{{Q}_{p} {v}_{i}^{2}}{{v}_{m}^{2}} ) ] ) {\hat{v}}^{Q} \qquad ( 56 )$$

That is, at step S370, the quantized compensation search vector zₜ, which is orthogonal to the search direction vector, may be calculated.

Here, at step S370, when the quantized learning equation does not escape from a local minimum point using the quantized orthogonal compensation search vector, the quantized learning equation may be made to escape from the local minimum point using the quantized compensation search vector.

Because the quantized compensation search vector has a scale of a quantization coefficient Qₚ, this may be calculated as the basic quantization compensation search vector, as shown in Equation (57).

$${z}_{t}^{Q} {=}^{Δ} \frac{1}{{Q}_{p}} {( {z}_{t} )}^{Q} \qquad ( 57 )$$

Also, at step S380, the quantized learning equation may be calculated.

That is, at step S380, based on the quantized compensation search vector defined in Equation (57), the quantized compensation search vector is multiplied by the quantized learning rate calculated using the quantized Armijo rule or the quantized line search algorithm, whereby the quantized learning equation shown in Equation (58) may be calculated.

The quantized learning equation shown in Equation (58) may be easily combined with the existing machine-learning or nonlinear algorithm.

xₜ₊₁^{Q}=xₜ^{Q}−λₜ^{Q}hₜ^{Q}, hₜ^{Q}=zₜ^{Q} (58)

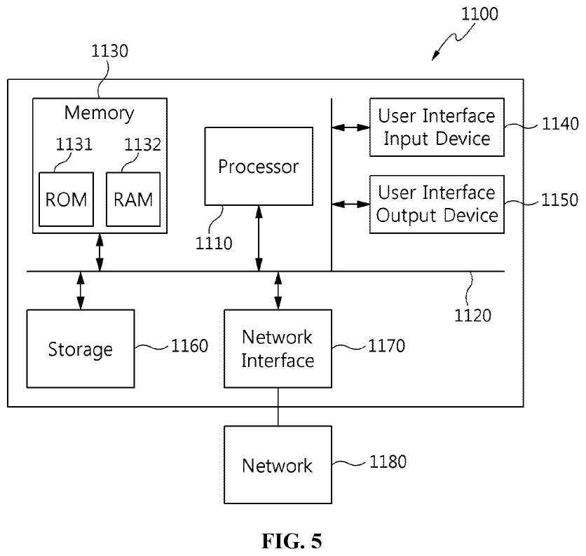

FIG. 5 is a view illustrating a computer system according to an embodiment of the present invention.

Referring to FIG. 5, the apparatus for optimizing a quantized machine-learning algorithm according to an embodiment of the present invention may be implemented in a computer system 1100 including a computer-readable recording medium. As illustrated in FIG. 5, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for optimizing a quantized machine-learning algorithm according to an embodiment of the present invention includes one or more processors 1110 and executable memory 1130 for storing at least one program executed by the one or more processors 1110. The at least one program may set the learning rate of the quantized machine-learning algorithm using at least one of an Armijo rule and golden search methods, calculate a quantized orthogonal compensation search vector from the search direction vector of the quantized machine-learning algorithm, compensate for the search performance of the quantized machine-learning algorithm using the quantized orthogonal compensation search vector, and calculate an optimized quantized machine-learning algorithm using the learning rate and the quantized machine-learning algorithm, the search performance of which is compensated for.

Here, the at least one program may set the learning rate through a learning-rate-setting function predefined by the Armijo rule using the gradient vector of the objective function of the search direction vector.

Here, the at least one program may set any one of a first candidate value, which is acquired by increasing the minimum candidate value of the learning rate by a golden ratio, and a second candidate value, which is acquired by decreasing the maximum candidate value of the learning rate by the golden ratio, as the learning rate.

Here, when the difference value between the first candidate value and the second candidate value is equal to or less than a preset value, the at least one program may set any one of the first candidate value and the second candidate value as the learning rate.

Here, the at least one program may select a vector in a direction orthogonal to the direction opposite the largest component vector of the search direction vector and quantize the selected vector, thereby calculating the quantized orthogonal compensation search vector.

Here, when the solution of the quantized machine-learning algorithm is not able to escape from a local minimum point, the at least one program may make the solution escape from the local minimum point using the quantized orthogonal compensation search vector.

The present invention may implement an optimization algorithm capable of minimizing a quantization error in machine-learning and nonlinear-signal-processing fields using quantization and exhibiting excellent performance on lightweight hardware.

Also, the present invention may implement a machine-learning algorithm capable of providing sufficient optimization performance even on low-performance hardware.

As described above, the apparatus and method for optimizing a quantized machine-learning algorithm according to the present invention are not limitedly applied to the configurations and operations of the above-described embodiments, but all or some of the embodiments may be selectively combined and configured, so that the embodiments may be modified in various ways.

What is claimed is:

1. An apparatus for optimizing a quantized machine-learning algorithm, comprising:
one or more processors; and
executable memory for storing at least one program executed by the one or more processors,
wherein the at least one program sets a learning rate of the quantized machine-learning algorithm using at least one of an Armijo rule and golden search methods, calculates a quantized orthogonal compensation search vector from a search direction vector of the quantized machine-learning algorithm, compensates for search performance of the quantized machine-learning algorithm using the quantized orthogonal compensation search vector, and calculates an optimized quantized machine-learning algorithm using the learning rate and the quantized machine-learning algorithm, the search performance of which is compensated for.

2. The apparatus of claim 1, wherein the at least one program sets the learning rate through a learning-rate-setting function predefined by the Armijo rule using a gradient vector of an objective function of the search direction vector.

3. The apparatus of claim 1, wherein the at least one program sets any one of a first candidate value, acquired by increasing a minimum candidate value of the learning rate by a golden ratio, and a second candidate value, acquired by decreasing a maximum candidate value of the learning rate by the golden ratio, as the learning rate.

4. The apparatus of claim 2, wherein the at least one program sets any one of the first candidate value and the second candidate value as the learning rate when a difference value between the first candidate value and the second candidate value is equal to or less than a preset value.

5. The apparatus of claim 1, wherein the at least one program selects a vector in a direction orthogonal to a direction opposite a largest component vector of the search direction vector and quantizes the selected vector, thereby calculating the quantized orthogonal compensation search vector.

6. The apparatus of claim 5, wherein, when a solution of the quantized machine-learning algorithm is not able to escape from a local minimum point, the at least one program makes the solution escape from the local minimum point using the quantized orthogonal compensation search vector.

7. A method for optimizing a quantized machine-learning algorithm, performed by an apparatus for optimizing the quantized machine-learning algorithm, comprising:
setting a learning rate of the quantized machine-learning algorithm using at least one of an Armijo rule and golden search methods;
calculating a quantized orthogonal compensation search vector from a search direction vector of the quantized machine-learning algorithm and compensating for search performance of the quantized machine-learning algorithm using the quantized orthogonal compensation search vector; and
calculating an optimized quantized machine-learning algorithm using the learning rate and the quantized machine-learning algorithm, the search performance of which is compensated for.

8. The method of claim 7, wherein setting the learning rate is configured to set the learning rate through a learning-rate-setting function predefined by the Armijo rule using a gradient vector of an objective function of the search direction vector.

9. The method of claim 7, wherein setting the learning rate is configured to set any one of a first candidate value, acquired by increasing a minimum candidate value of the learning rate by a golden ratio, and a second candidate value, acquired by decreasing a maximum candidate value of the learning rate by the golden ratio, as the learning rate.

10. The method of claim 9, wherein setting the learning rate is configured to set any one of the first candidate value and the second candidate value as the learning rate when a difference value between the first candidate value and the second candidate value is equal to or less than a preset value.

11. The method of claim 7, wherein compensating for the search performance is configured to select a vector in a direction orthogonal to a direction opposite a largest component vector of the search direction vector and to quantize the selected vector, thereby calculating the quantized orthogonal compensation search vector.

12. The method of claim 11, wherein compensating for the search performance is configured such that, when a solution of the quantized machine-learning algorithm is not able to escape from a local minimum point, the solution is made to escape from the local minimum point using the quantized orthogonal compensation search vector.
